(19) United States
(12) Patent Application Publication
(10) Pub. No.: US 2006/0161297 A1
(43) Pub. Date: Jul. 20, 2006

(54) Method for operating a vending machine and vending system

(75) Inventors: Boris Mayer, Bonn (DE); Tanja Tekin, Bonn (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/524,042

(22) PCT Filed: Aug. 7, 2003
(86) PCT No.: PCT/DE03/02700

§ 371 Date: Feb. 4, 2005

(30) Foreign Application Priority Data
Aug. 16, 2002 (DE) 102 38 341.3

(51) Int. Cl. G06F 17/00

(52) U.S. Cl. 700/244

(57) ABSTRACT

A method for operating a vending machine, whereby goods can be arranged in storage compartments and can be subsequently removed therefrom. Offer-related data are captured in a central data processing unit, whereby matching offers are associated with identical offer identification codes such that offer identification codes are transmitted to a plurality of electronic vending machines, and storage compartments which are provided for the distribution of goods are stocked with goods, and offer identification codes associated with the goods are captured. A vending system including a plurality of vending machines, and individual vending machines for carrying out the method, are disclosed.

The invention relates to a method for operating a vending machine, whereby goods can be placed into storage compartments and can be subsequently removed from the storage compartments by customers.

The invention also relates to a vending system.

A number of methods are known for selling goods by means of automated vending machines.

Through prior public use, vending machines are known that comprise a plurality of compartments which contain a number of goods. The vending machines also comprise a coin slot mechanism. If a user deposits an amount of money, he can select individual goods dispensing compartments until the monetary amount has been used up, so that the goods associated with the goods dispensing compartments can be dispensed.

Furthermore, individualized vending machines are known with which various vendors have access to a locker system and a computing unit linked to it. This is where individual conditions for the withdrawal of goods are stipulated.

The invention is based on the objective of finding a method that combines the advantages of the known methods.

In particular, it is the objective of the invention to create a method for the automated selling of goods which makes it possible to offer articles while achieving the greatest possible flexibility and, at the same time, the greatest possible capacity utilization of the dispensing compartments.

According to the invention, this objective is achieved in that a method of the type described above is carried out in such a way that offer-related data is recorded in a central data processing unit, whereby matching offers are associated with identical offer identification codes, that the offer identification codes are transmitted to a plurality of electronic vending machines, that storage compartments which are provided for the distribution of goods are stocked with goods, and that offer identification codes associated with the goods are recorded.

The offer-related data preferably comprises at least one piece of information about the identification of a type of goods and/or amount of goods as well as preferably also the price to be paid for the goods. The term offer-related data is by no means to be construed in a restricting manner. In particular, other information such as the quality and the features of the goods can be the subject matter of the offer-related data.

The offer identification codes are preferably recorded when the storage compartments of the vending machines are stocked with goods. This particularly preferred embodiment of the invention comprises especially the following cases:

1. First of all, the offer identification code of the goods is recorded and subsequently the goods are placed into the storage compartment;

2. During the placement of the goods into the storage compartment, the offer identification code is recorded (for example, automatically by recording the information that is linked to or can be linked to the goods).

The cases shown here are preferably freely selectable, whereby especially preferred embodiments are characterized in that the processes of placing the goods and recording the identification codes can be combined with each other in order to achieve the fastest possible completion of the goods placement procedure and of the data recording. Moreover, this has the advantage of preventing that different goods are inadvertently switched.

The invention entails numerous advantages. In particular, the invention makes it possible to operate the vending machine under flexible operating conditions. For example, it is possible on short notice to enter and change selling times, prices and offer contents in the vending machine or in a—preferably central—database that can be connected to the vending machine. Moreover, it is possible to set up specific offers for specific customers or customer groups.

It is especially advantageous for the offer identification codes to be recorded before the compartments of the vending machine are stocked with the goods.

Moreover, it is advantageous for the placement of the goods into the vending machines to be transmitted to the central data processing unit.

In this manner, it is possible to incorporate the individual vending machines into a central goods management system.

Furthermore, in this manner, offer-related data can be specified for a plurality of vending machines.

Another especially advantageous embodiment of the invention is characterized in that data for controlling the vending machine is stored in the central data processing unit, this data is converted into control commands for controlling the vending machine and the control commands are transmitted to the vending machine.

Moreover, it is advantageous to refine the invention in such a way that the control commands change operating parameters of the vending machine.

Another especially advantageous embodiment of the invention is characterized in that the control commands interact with an electronic control unit located in the area of the vending machine in such a manner that the selection of the available operating functions can be changed.

Furthermore, it is advantageous to refine the invention in such a way that the control commands are transmitted according to an XML protocol.

Another especially advantageous embodiment of the invention is characterized in that the vending machine sends a request for the transmission of control commands to the central data processing unit.

Moreover, it is advantageous to refine the invention in such a way that the request for the transmission of control commands is repeated when an event occurs.

Another especially advantageous embodiment of the invention is characterized in that the request is repeated after a predefinable time interval.

Moreover, it is advantageous to refine the invention in such a way that, in the area of the central data processing unit, a procedure checks whether changes have been made in the offer-related data stored in the central data processing unit and/or control data, and that, in case of changes in the offer-related data stored in the central data processing unit and/or control data, a control command is transmitted to the vending machine.

An especially advantageous embodiment of the invention is characterized in that, in the central data processing unit and/or in the vending machine, information about different user groups of the vending machine and information about the selection of individual offers are stored as a function of the appertaining user groups.

An especially preferred embodiment of the invention is characterized in that mailpieces are transported to the vending machines, placed into at least some of the storage compartments and stored there for later pick-up.

Moreover, it is advantageous for mailpieces to be recorded by the vending machine and to be placed into at least some of the storage compartments, and for the mailpieces to be taken out of the storage compartments at a later point in time.

Another subject matter of the invention is a vending system comprising a plurality of vending machines which is characterized in that the vending system comprises a central data processing unit in which information is stored about the goods present in the vending machines.

Moreover, it is advantageous to refine the invention in such a way that the data processing unit is equipped with an interface that allows external access to at least some of the information about the goods that is stored in the data processing unit.

Another especially advantageous embodiment of the invention is characterized in that the external access to some of the information about the goods that is stored in the data processing unit is effectuated via the Internet.

The invention also comprises a vending machine with storage compartments for storing goods. This vending machine is characterized in that the vending machine and/or a central data processing unit connected to it comprises means for a flexible allocation of the storage compartments for a vending system and/or for a logistic system for sending and/or picking up goods.

Further advantages, special features and advantageous embodiments of the invention ensue from the subordinate claims and from the following presentation of preferred embodiments, making reference to the drawings.

The drawings show the following:

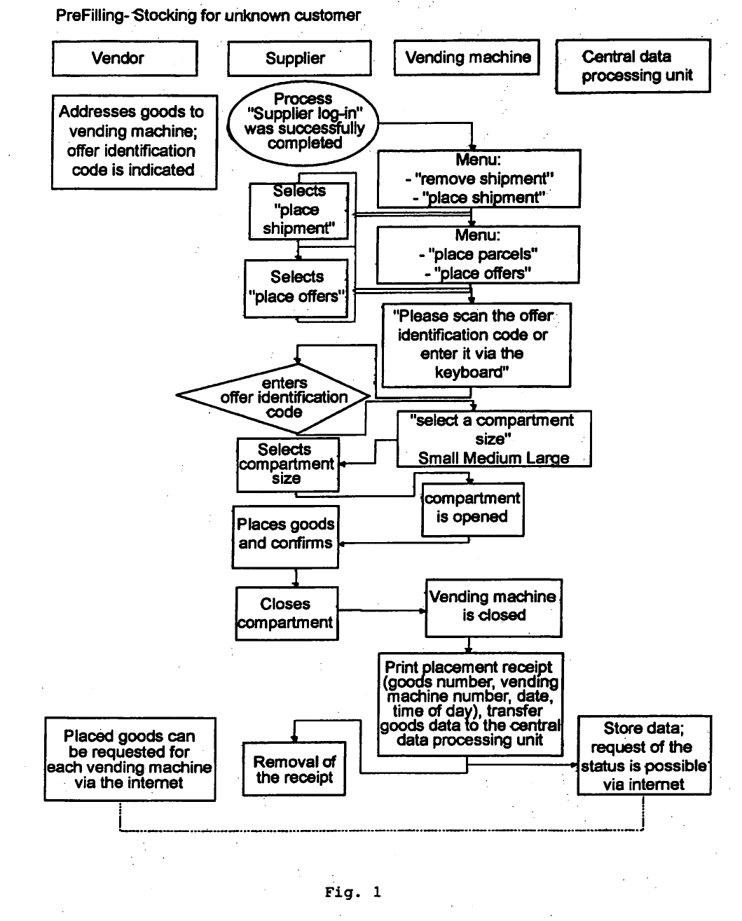

FIG. 1 a block diagram with processing steps of an especially preferred stocking of compartments of the vending machine,

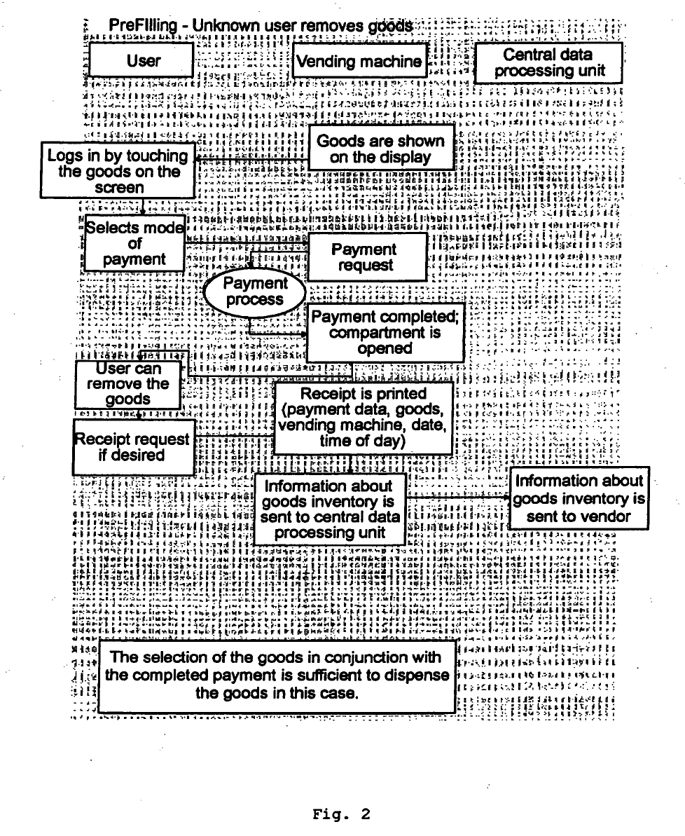

FIG. 2 a block diagram of an especially preferred removal of goods from the vending machine and

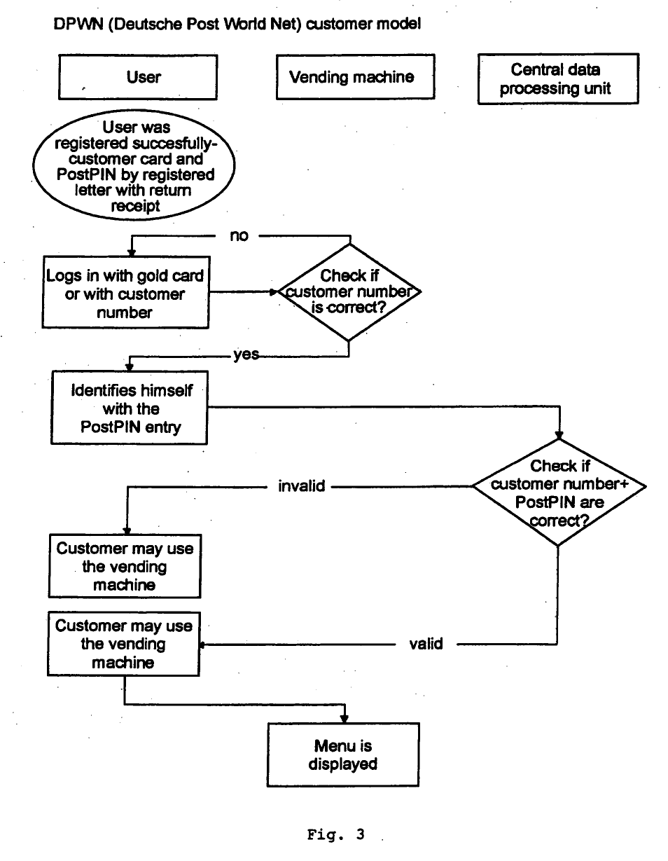

FIG. 3 a block diagram with processing steps for an access authorization to the vending machine.

The invention is especially well-suited for selling standardizable mass-produced goods that are sold preferably in large numbers by one or—which is especially preferred—several vending machines.

An especially preferred embodiment of the invention is characterized in that the vending machine is additionally operated as an electronic parcel compartment system and is thus used for delivering and/or picking up mailpieces.

The invention allows the automated sale of goods, whereby the selection of the available goods can be changed on short notice and whereby selling and offer-related conditions are controlled centrally and/or can be changed as a function of external conditions.

This flexibility of the offers makes it possible, for example, to sell goods only after a certain date, especially after a certain time of day. This is particularly significant in the case of articles that are only supposed to be sold after a certain point in time. For example, the selling conditions of new editions of certain goods, especially books and films or audio media, require that they may only be sold after a certain date or after a certain time of day.

The invention makes it possible—also while otherwise not changing the operation of the vending machines—to sell individual goods and groups of goods only at certain times.

Moreover, through the invention, it is possible to sell goods at different times under different conditions. For example, individual products can be sold at variable prices, for example, as a time-limited special offer, or as a sale, for example, in the case of end-of-season sales.

Additional selling conditions of the vending machine, or of a vending system encompassing several vending machines, can be adapted to different needs.

Thus, it is possible to sell individual goods only to certain users, or to certain user groups, under special conditions as well as to use the same vending machine for the sale of goods in a way that is as automated as possible.

The invention entails the special advantage that it allows an anonymous (mass) sale of goods as well as a targeted selling of goods to individual customer groups.

In particular, customers can be informed via the mass media, in other publicly accessible media, for example, via the Internet, or directly at the vending machines, about the available offers and these customers can utilize these offers without their being identified.

This is especially important from the viewpoint of the protection of the privacy of the user.

Moreover, the invention allows goods to be reserved for individual customers, so that the vending machine allows a reliable execution of purchase orders.

Preferably, the vending machine is operated in such a way that the reservation remains valid for a certain time interval and/or by a predefinable time interval so as to avoid a fraudulent blocking of the vending machine by purchasing offers that are not genuine.

By changing the operating parameters, the reservation capabilities can be activated or deactivated for certain user groups as desired.

A selection of the goods and the completion of payment are sufficient for removing the goods. The customer remains anonymous vis-à-vis the vending machine and preferably also vis-à-vis the central data processing unit that controls the vending machine; only payment data might possibly allow his identity to be traced. However, it is also possible to avoid identifying customers through the payment procedure, for example, in that anonymous means of payment such as, for example, money cards or monetary-value information are used.

In the case of fast-moving products, usually quick-selling goods, it is especially advantageous to achieve a storage duration of preferably two days at the maximum. The fast-moving products such as, for example, in the same way as specials in branch stores, can change weekly. It is also conceivable to offer just one fast-moving product per week.

In order to ensure the highest possible capacity utilization of the vending machine, it is advantageous to configure the stocking options for individual storage compartments of the vending machine so variably that the vending machine can also be used as en electronic parcel compartment system.

Through this flexible configuration of the vending machine as an electronic parcel compartment system, the highest possible capacity utilization of the vending machine can be achieved.

The selling offers are preferably selected in such a way that they are of interest to a large pool of customers so as to ensure the highest possible turnover rate of goods. The pre-filling of the vending machine can be done on the basis of concrete customer requests as well as also without such customer requests.

The modality of filling the vending machine before there are any customer requests will be referred to as PreFilling below.

The PreFilling offers can be planned together with shippers. Such special sales can be carried out as an event at special times during which the shipping volume is not very high, for example, during the summer break. During this time, there are new products once or twice per week.

Special product editions that may only be sold after a certain date such as, for instance, books, should additionally be placed into specific vending machines. In the case of date-restricted goods, one can take advantage of the fact that the goods are available for 24 hours per day by making the goods available starting at midnight. The customer is informed to this effect through an appropriate notification, for example, an e-mail or an SMS. A software update can make the goods available at the vending machine after a certain point in time, already before the opening of the stores, for example, starting at midnight.

For a certain time, a certain number of compartments can be (additionally) leased to vendors or reserved for the special summer sale.

The method allows the inclusion of users who are known to the system as well as of users who are not known to the system. All interested parties, that is to say, registered as well as unregistered users, should be able to take the goods out of the vending machine in exchange for payment. Once the user has paid, he is entitled to remove the goods. No further identification is needed. The customer can remain anonymous vis-à-vis the vending machine and the central data processing unit that controls the vending machine.

Especially preferred properties of the vending system are listed below:

An especially preferred embodiment of the invention, particularly of the vending system according to the invention, is characterized in that information about the goods available in the vending machine and/or about the data of the vending machine can be accessed externally, for example, via the Internet.

Moreover, it is advantageous to furnish the vending machine with at least one of the features listed below or with a combination thereof:

The vending machine shows which goods are available.

A payment function for special sale products is present at the vending machine.

The vendor role is integrated (special sale products can be placed)

The deliverer can likewise place special sale products (placement without postal number)

Direct addressing of a vending machine is possible

A user can also remove special sale products without a LogIn, but as an alternative, registered users can remove the goods with an appropriate access card, for example, a gold card and authorization information, especially a PostPIN.

The vending machine and/or the central data processing unit that controls it can optionally produce, issue and administer order numbers and TAN's (transaction numbers) (both or either one)

Receipt printing is possible

The invention preferably entails a flexible stocking of the vending machines. The goods can be placed into the vending machine ahead of time, especially in the case of date-sensitive editions. The Screen Update, on which the product can be selected via a link, is then activated exactly at midnight.

During the stocking of the vending machine, the ‘stocker’ selects the menu item ‘set offer’. If there are several products per shipper, it has to be possible to unambiguously associate the content with the shipment.

If so desired, the stocking of the compartments can be stocked via the normal delivery modality. The goods would be addressed directly to this PARCEL STATION and the deliverer would place them during the normal delivery to the vending machine.

### EXAMPLE

Offer 1 or: allocation is made by means of the goods code as a barcode

PARCEL STATION 101

55116 Mainz, Germany

The vendor can also organize or carry out the stocking himself; then individual entries have be made at the vending machine such as, for example, product information that the deliverer does not know or, for lack of time, could not enter.

An especially preferred stocking modality of the vending machine is shown in FIG. 1. This stocking modality is especially well-suited for the sale of goods to users who are not identified vis-à-vis the vending machine and/or who are not registered users of the vending machine.

The vending system shown in FIG. 1 preferably comprises four participants. These include a vendor who can address goods to the vending machine. Preferably, an offer identification code is indicated here. The term “vendor” is by no means to be construed as a restriction. In particular, it also encompasses an electronic trading system that, in an especially preferred embodiment, can be fully automated. Moreover, it is possible to use software agents. Software agents, which are also referred to as intelligent agents, are preferably made up of software units that monitor their environment and act automatically. In an especially preferred embodiment, the software agent is configured in such a way that it can respond flexibly to requests of customers and to the presence of goods production and/or goods delivery possibilities as well as preferably also to other parameters.

The vending machine used for executing the method, or for implementing the vending system, is such that it is as well-suited for placing and dispensing goods shipments as it is for placing and dispensing mailpieces, particularly postal parcels.

Individual vending machines or—which is especially preferred—all of the vending machines are connected to a central data processing unit. The central data processing unit contains information about goods present in the vending machines as well as preferably also about sales queries or delivery requests to individual vending machines.

The vending system described here allows various implementations of the method. The process steps shown in FIG. 1 are merely intended by way of example.

Preferably, these process steps comprise at least a few of the following process steps, especially a combination of the process steps shown here, whereby adherence to the sequence is not necessary, but is preferred in order to enhance the efficiency of the method.

Deliverer/Stocker has logged in successfully (gold card+PostPIN)

The deliverer chooses between ‘remove shipment’ and ‘place shipment’.

Once ‘place shipment’ has been chosen, the following selection appears: ‘place parcels’, ‘place offers’.

The deliverer chooses ‘place offers’; then he is prompted to enter the offer number.

After the entry has been completed, the desired compartment size is asked.

After the compartment size has been selected, the deliverer places the parcel into the compartment, closes it and confirms the placement.

The vending machine (PARCEL STATION) prints a receipt with the data (goods number, PARCEL STATION number, date, time of day).

The parcel data is forwarded to the central data processing unit.

If the person in question is a stocker but not a deliverer, he may only see the functions in the menu sequence that he is entitled to use in view of his function. In points 2 and 3, only the option of placing offers would be visible.

The invention entails various realization possibilities for a goods preview and/or a reservation of the goods. The special sale products in question are advertised ahead of time—for example, on the homepage or in cooperation with shippers. The possibility of providing a vending machine-related special sale product preview should likewise exist on the homepage.

That is where the current products and the vending machine locations are listed. Search function for products and the city and location (e.g. centrally located; near downtown; P&R parking places) should be integrated. The customer should be able to see if only a few more of the products are still available.

If cooperation arrangements with vendors exist, they should also make reference to the vending machine preview.

For non-customers, the vending machine preview only serves for information purposes.

Customers of the logistic system should be given the possibility to reserve a product (e.g. for two hours). For this purpose, there is a LogIn (especially by entering the postal number and the Internet password). Thus, up to x articles can be reserved, optionally only for a limited period of time.

In the database, the person picking up the goods or the goods number is overwritten. The previous order number is replaced by the customer number. The customer number is only valid in conjunction with the PostPIN.

A preferred embodiment of a removal of goods by customers is shown in FIG. 2. The depicted embodiment is especially well-suited for the removal of goods that had not been previously reserved.

In particular, the embodiment whose block diagram is shown in FIG. 2 is suitable for selecting goods in the area of the vending machine. Preferably, for this purpose, the vending machine is equipped with a graphic display means for displaying at least some of the goods being offered. An especially suitable display means is a touch screen since it concurrently allows the offered goods to be selected in a simple manner.

Those interested (they can but do not have to be customers of the logistic system) can select an offer via the touch screen.

Preferably, with this embodiment of the invention, at least a few, preferably several, of the following process steps are used:

Offer is displayed on the screen

A product can be selected by means of touching

The user can now select the desired mode of payment

The payment prompt is displayed

Payment procedure

Payment was made successfully→8

Payment was not completed→error message→logout

The user can remove the shipment

The user can request a receipt

The receipt is printed (payment data, goods, identification information about the vending machine, date, time of day)

Information about the current goods inventory is sent to the central data processing unit

Goods inventory is sent to the vendor

The vending procedure shown in FIGS. 1 and 2 can fundamentally be used for the removal of reserved goods.

In order to ensure that the person who reserved the goods is the one who actually receives them, an authorization check is advantageous. An especially preferred embodiment for the removal of reserved goods is explained below with reference to FIG. 3.

FIG. 3 shows a block diagram of an access process for users of the vending machine, whereby the access procedure is suitable for access to the vending machine in its function as a vending machine as well as in its function as an electronic parcel compartment system.

During the reservation period of time (e.g. 2 hours), customers of the logistic system who have reserved goods can remove the goods by using the same process as for parcels located in the vending machine:

LogIn with gold card and PostPIN

Goods or else shipments are displayed

Customer is prompted to make payment

After the payment has been completed, the goods can be removed

Refilling

As soon as certain goods have been sold out, the system can generate an e-mail or SMS to the vendor with all of the necessary information for purposes of restocking.

Address of the vending machine (PARCEL STATION 101; 55116 Mainz, Germany)

Type of goods (the goods or offer characteristic)

Number of items (e.g. 5)

This notification is preferably equivalent to an order.

The embodiments of the invention shown are merely to be understood by way of example. In particular, it is possible and advantageous to integrate additional functions into the vending machine. This additional information allows the integration of additional information into the vending machine such as, for example, the selection possibilities described for using the vending machine for reserved as well as for unreserved goods, as well as the combination of the use of an electronic parcel compartment system with storage compartments as a vending machine and also as an electronic parcel compartment system. Especially preferred embodiments of the invention entail the most flexible possible division of the electronically controlled compartment system into an anonymous vending machine, a vending machine operated in a reservation mode, a vending machine for pre-ordered goods and an electronic parcel compartment system for dispensing and/or accepting mailpieces, especially postal parcels.

1.-20. (canceled)

21. A method for controlling a vending machine in which goods can be placed into storage compartments and can be subsequently removed from the storage compartments by customers, offer-related data are recorded in a central data processing unit, whereby matching offers are associated with identical offer identification codes, the offer identification codes are transmitted to a plurality of electronic vending machines, storage compartments are provided for the distribution of goods are stocked with goods, and offer identification codes associated with the goods are recorded, the method comprising the steps of
(a) storing data for controlling the vending machine in the central data processing unit, converting this data into control commands for controlling the vending machine, and transmitting the control commands to the vending machine,
(b) in the case where the stored data are changed, transmitting control commands to the vending machine to change the operating parameters of the vending machine, said operating parameters being selected from the group consisting of at least selling times, prices, offer contents, offers as a function of user groups, and the number of operating functions, and
(c) interacting the control commands with an electronic control unit located in the area of the vending machine so as to change the selection of the available operating functions wherein a first operating function entails the use of the compartments for a vending system and a second operating function entails the use of the compartments for a logistic system for sending and/or picking up goods.

22. The method of claim 21, comprising transmitting the placement of the goods into the vending machines to the central data processing unit.

23. The method of claim 21, comprising displaying the filling of the compartments with the goods by means of a graphic display unit.

24. The method of claim 21, comprising reserving goods in individual compartments for a certain period of time.

25. The method of claim 21, comprising storing in at least one of the central data processing unit and in the vending machine, information about different user groups of the vending machine and information about the selection of individual offers a function of the appertaining user groups.

26. The method of claim 21, comprising transporting mailpieces to the vending machines, placing and storing mailpieces in at least some of the storage compartments for later pick-up, recording the mailpieces by the vending machine and removing the mailpieces from the storage compartments at a later point in time and transporting the mailpieces to a destination.

27. A vending machine with storage compartments for storing goods, comprising a central data processing unit (CPU) connected to the vending machine and an electronic control unit located in the area of the vending machine, the CPU comprising means for flexibly allocating the storage compartments for at least one of a vending system and a logistic system for sending and/or picking up goods, whereby the allocation means can generate control commands and can transmit them to the vending machines, and the control commands interact with the electronic control unit in such a manner that the selection of the available operating functions is changed, and wherein a first operating function entails the use of the compartments for a vending system and a second operating function entails the use of the compartments for a logistic system for sending and/or picking up goods.
